(19) United States
(12) Patent Application Publication
(10) Pub. No.: US 2014/0207545 A1
(43) Pub. Date: Jul. 24, 2014

(54) METHOD AND SYSTEM FOR FACILITATING MERCHANT-CUSTOMER RETAIL EVENTS USING A FINANCIAL TRANSACTION FACILITATION SYSTEM

(71) Applicants: Brett Aksel Berman, Westlake Village, CA (US); Timothy Edward Rothwell, II, Austin, TX (US)

(72) Inventors: Brett Aksel Berman, Westlake Village, CA (US); Timothy Edward Rothwell, II, Austin, TX (US)

(21) Appl. No.: 14/160,857

(22) Filed: Jan. 22, 2014

Related U.S. Application Data
(60) Provisional application No. 61/755,186, filed on Jan. 22, 2013.

(51) Int. Cl. G06Q 30/02; G06Q 20/06

(52) U.S. Cl. CPC G06Q 30/0222; G06Q 20/065
USPC 705/14.13; 705/14.23

(57) ABSTRACT

Method and system is disclosed for facilitating merchant-customer retail events using a financial transaction facilitation system. The system selectively registers merchant-vendors and system-users. Offers by merchant-vendors are purchased by system-users for redemption at selectable times and physical locations. The purchases are made using a third-party artificial currency system. Payment by the third-party artificial currency system is authenticated and applied to the merchant-vendor upon purchase confirmation and validation.

### CROSS REFERENCE TO RELATED APPLICATIONS

This application claims the benefit of Provisional Application No. 61/755,186 filed on Jan. 22, 2013 which is hereby incorporated herein by reference.

### TECHNICAL FIELD

This disclosure relates to systems used to offer goods or services to consumers, and more particularly to financial transaction facilitation systems.

### BACKGROUND

The statements in this section merely provide background information related to the present disclosure and may not constitute prior art.

The current approach to an organizational sponsored artificial currency offering includes a central access data system at the sponsoring organization that maintains reconciliation of all account holder's credits and debits. Point-of-sale terminals are physically located at participating merchant-locations. The terminals operate to perform general financial transactions and execute general financial events such as balance queries and initiate currency transfers. To initiate a sale or assign a credit, the terminal typically will reserve a portion of an account holder's balance for a particular purchase. The terminals are generally configured with a “smartstrip,” magnetic stripe reader, or RFID. For University or organizational applications, student's information is generally stored on a magnetic stripe on a plastic identification card. For applications utilizing an artificial currency, the participating merchants are typically leased terminals after agreeing to the terms and conditions of the Organizations artificial currency program.

There are numerous disadvantages to the point-of-sale terminal-based system. For example, unscrupulous persons have been able to discreetly utilize card readers or other technology to steal, or copy without permission, information associated with a consumer's card such as a card number, name, address or any other information stored on the smartstrip. The terminal-based systems can be expensive and contribute to a cluttered checkout desk. Furthermore, participation in artificial currency systems typically require contracts and contractual maintenance between the merchant and the organization and between the participant-consumer and the organization.

Therefore, it would be advantageous to utilize a mobile-based system configured to participate in an artificial currency system.

### SUMMARY

Method and system is disclosed for facilitating merchant-customer retail events using a financial transaction facilitation system.

Method and system is disclosed for facilitating merchant-customer retail events using a financial transaction facilitation system. The system selectively registers merchant-vendors and system-users. Offers by merchant-vendors are purchased by system-users for redemption at selectable times and physical locations. The purchases may be made using a third-party artificial currency system. Payment by the third-party artificial currency system is authenticated and applied to the merchant-vendor upon purchase confirmation.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows a retail system communicatively connected to an exemplary mobile device, in accordance with the present disclosure;

FIG. 2 shows an exemplary user interface for a mobile device, in accordance with the present disclosure;

FIG. 3 shows an exemplary control scheme, in accordance with the present disclosure;

FIG. 4A-4D show exemplary user interfaces for a mobile device, in accordance with the present disclosure;

FIG. 5 shows an exemplary control scheme, in accordance with the present disclosure; and

FIG. 6 shows an exemplary implementation of the financial transaction facilitation system, in accordance with the present disclosure.

### DETAILED DESCRIPTION

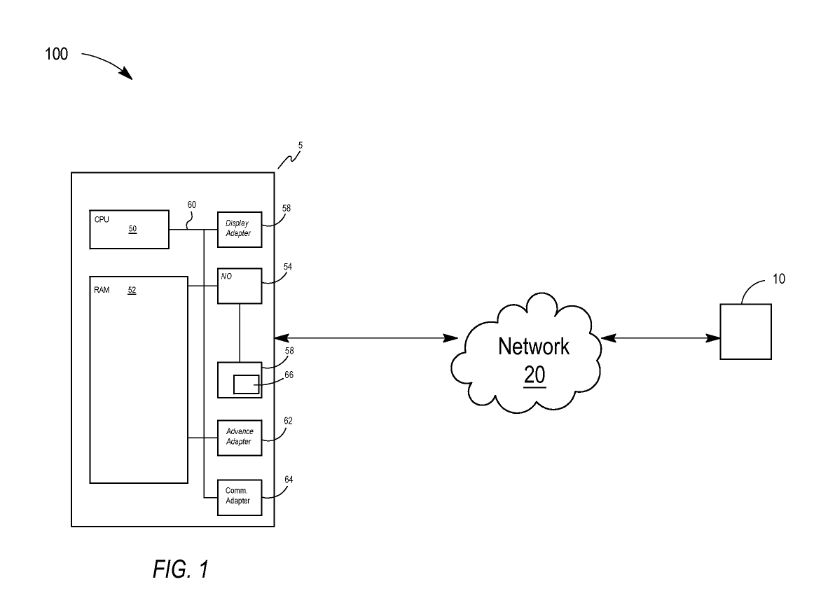

Referring now to the drawings, wherein the depictions are for the purpose of illustrating certain exemplary embodiments only and not for the purpose of limiting the same, FIG. 1 schematically shows an exemplary financial transaction facilitation system 100 that may help implement the methodologies of the present disclosure. The system 100 includes a server 5, a network 20, and a mobile device 10. As shown in FIG. 1, the server 5 may be directly communicatively connected and communicatively connected via the network 20. The mobile device 10 is preferably wirelessly communicatively connected to the network 20. Components of the communication system 100 are shown in FIG. 1 as single elements. Such illustration is for ease of description and it should be recognized that the communication system 100 may include multiple additional implementations of the components, e.g., a mobile device may be physically connected to the network 20 during selected periods of operation.

The network 20 may be any suitable series of points or nodes interconnected by communication paths. The network 20 may be interconnected with other networks and contain sub networks network such as, for example, a publicly accessible distributed network like the Internet or other telecommunications networks (e.g., intranets, virtual nets, overlay networks and the like). The network 20 facilitates the exchange of data between the mobile device 10 and the server 5. The most common topologies or general configurations of networks include bus, star and ring topologies. Networks can also be characterized in terms of spatial distance as local area networks (LANs), metropolitan area networks (MANs) and wide area networks (WANs). Further, memory located in or associated with the network 20 may contain algorithms or applications for executing functionality described herein.

The server system 5 may be one or more of various embodiments of a computer including high-speed microcomputers, minicomputers, mainframes, and/or data storage devices. The server 5 preferably executes database functions including storing and maintaining a database and processes requests from the mobile device 10 to extract data from, or update, a database as described herein below. The server may additionally provide processing functions for the mobile device 10.

The mobile device 10 may be any type of communications or mobile computing device including e.g., a cellular phone, digital media player (e.g., audio or audio/video), personal digital assistant (“PDA”), e-readers, vehicle infotainment systems, navigation systems and a smart phone, which is a combination mobile telephone and handheld computer having PDA functionality. PDA functionality can comprise one or more of personal information management, database functions, word processing, spreadsheets, voice memo recording, location-based services, device backup and lock, media playing, Internet browsing, etc. and is configured to synchronize, publish/subscribe, download, or otherwise communicate personal information or user data (e.g., contacts, e-mail, calendar, notes, to-do list, web browser favorites, etc.) from one or more applications with a computer (e.g., desktop, laptop, server, etc.). The mobile device 10 preferably includes GPS functionality. In these embodiments, a GPS may determine the location of the mobile device based on data exchanges between the GPS and the mobile device. Other location services may be implemented to determine mobile device location. In some embodiments, for example, network elements may be used to determine location of the mobile device using triangulation of network signals, for example. Location may be determined at various intervals, upon occurrence of trigger events, upon requests, or the like.

In addition, the mobile device 10 may include one or more applications that the consumer may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The application may organize input from the mobile device and transmit such input to the server 5 via the network 20. The application may also organize and display output received from the server 5 for the consumer, as will be described below. More specifically, the application allows the consumer to request offers based on identified Merchants. The application may acquire the location of the mobile device from the GPS, and in some instances, historical location information, and transmit the location to the server 5.

The server 5 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the server 5 to the network 20. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data.

The central processing unit 50 is preferably a general-purpose microprocessor or central processing unit and has a set of control algorithms, comprising resident program instructions and calibrations stored in the memory 52 and executed to provide the desired functions. As one skilled in the art will recognize, the central processing unit 50 executes functions in accordance with any one of a number of operating systems including proprietary and open source system solutions. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on platforms and operating systems other than those mentioned.

The memory of the server 5 may include various storage databases including an offer database and consumer data database. Merchants may populate the offer database with offers as described herein below. In some embodiments, the merchants may use a virtual storefront to specify and transmit the details of offers. The virtual storefront may be a website that is specific to a particular merchant. In one embodiment, consumers may have access to both the virtual storefront for each merchant and the application. In another embodiment, the consumers may only have access to the application. In yet another embodiment, each merchant need not necessarily have its own virtual storefront. In other words, merchants may access a shared portal for transmitting offers to the system, whether the shared portal is a website, a program, etc. Merchants could log in to the shared portal with a unique username and password.

Still further, the system may compile information about specific consumers in the consumer data. For example, such information about consumers may include without limitation current locations, buying habits, recurring routes, preferences, interests, favorite merchants, purchase times, times at which offers are requested, and types of offers requested. Registered merchants may then use this information from the data records to develop even more intelligible targeting schemes. For example, a merchant could generate different offers for different consumers. Or the merchant could extend a personalized offer to a consumer during a specific time during the week when the consumer has purchased products from the merchant in the past. Or the merchants could analyze the data to determine which offers are most successful. One way for the merchants to obtain this information is through accessing their virtual storefronts or the shared portal.

The processor of the server 5 may perform the operations of user's as requested via the mobile device 10 and/or Merchants as requested by a computer system. To illustrate, the processor may organize and analyze raw data received from the mobile device and/or computer system. The processor may then store this data in the data records for merchant access. Similarly, the processor may select offers in the offer database based on the types of products and/or services that have been requested from the mobile device of the consumer. Selecting may include matching, filtering, choosing, deciding, electing, marking, picking, sorting, or otherwise refining the total number of offers before presentment to the consumer. The processor may additionally, or in the alternative, select offers based on the locations of the consumers. Still further, the processor may render expired offers in the offer database as being no longer redeemable based upon selected parameters as described herein below as defined by a Merchant.

After valid offers from the offer database are selected, in some cases based on the criteria discussed above, the server 5 may convey or transmit such offers back to the mobile device 10. The application of the mobile device may organize the offers and present them to the consumer in a user-friendly format as described and shown in the corresponding drawings. For example, the application may display the offers in a chart that indicates the offer and the expiration time or quantity available. As a further example, the application may present the offers to the consumer as being graphically superimposed onto a localized map.

Once the consumer is presented with offers from merchants, the consumer may wish to accept an offer. The discount retailing system contemplates many methods through which the consumer may take advantage of a particular offer that the application presents.

The consumer may select a desired offer by indicating so through the application on the mobile device. The application may send a signal via the network to the server 5 indicating that the consumer would like to accept the offer from a particular merchant. Thereafter, the server 5 may generate an alphanumeric code, a QR code, an electronic serial bar code, or some other unique identifier that is transmitted to both the application of the mobile device 10 and the merchant. In the alternative, merely information associated with the unique identifier may be sent to the merchant so that the merchant can recognize the unique identifier. The consumer may then show the merchant the unique identifying information upon redeeming the offer for the product, service, etc. It should be noted that real-time offers may also work in conjunction with the point system, as described previously.

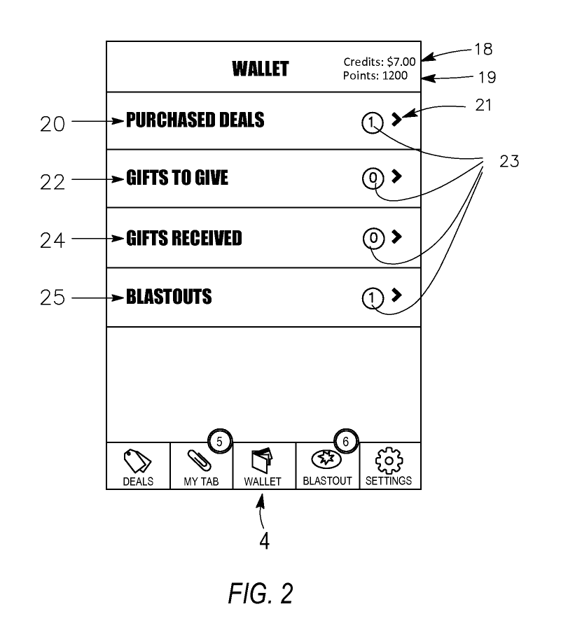

FIG. 2 shows an exemplary user interface associated with executing financial transactions. As described herein above, the user's mobile device may store information about a purchase transaction, such as information about purchased items, item prices, a location where items were purchased, and information about a method of payment, etc. (e.g., via an electronic receipt). The virtual wallet may further store information that can be used in transactions and/or other types of information. For example, information associated with a credit card, automated teller machine (ATM) card, driver's license, bank account, artificial currency system, and/or other types of information may be stored or associated with the virtual wallet. The mobile device 10 may send stored information to a destination, such as a remote storage device operating on the server 5.

The server 5, then in one embodiment, may further communicate with a third party on behalf of the mobile device 10. For example, the third party may be a bank or other financial organization that maintains financial accounts for a user listed and authorized in the virtual wallet. The server 5 may contact the mobile device 10 on behalf of the bank or financial organization and may process transactions between the mobile device 10 and the bank (third party). Additionally, the third party may include a device that sends or receives information via the network 20 such as a device that verifies a credit card number.

In particular, FIG. 2 shows various navigational buttons and informational modules and indicia including: Credit Balance in UMT Wallet 18, Loyalty Point Balance in UMT Wallet 19, Purchased Deals 20, Advance to Purchased Deals 21, Gifts purchased to Give 22, an Indicator of Purchased Deals 23, Gifts Received from Others 24, and Blast Outs 25.

Functionality of the virtual wallet may include: Allowing third parties to gift into the wallet, either digital cash or coupons. (e.g., a parent can “gift” into a child attending university, or to an aging parent) Integrating with third party providers of institutional “currency” i.e., artificial currency, for example University Student Credit Voucher programs, and allowing a user to select the University Currency, or some combination of system defined currency, University Currency, and a third credit card or debit card, integration with a proprietary “reward point system” for activity as a UMT Consumer. Artificial currency may be measure in predefined ratio to actual currency or based upon a complex point-based metric removed from an actual currency equivalence metric. In some embodiments, university programs allow students or user to perform incentive-based activities and thereby receive points, the points redeemable for products or services offered by merchants that accept the currency. Further, the virtual wallet may allow the user to select either a credit, gift, or buy a coupon and gift to a named third party such as another system user. In one embodiment, the virtual wallet integrates records of purchases with current merchant interaction. Various user data associated with the virtual wallet may be stored locally or remotely. Purchased coupons information may be stored in the virtual wallet until redemption. In one embodiment, the virtual wallet integrates with refund and or credits from system merchants, so all transactions, purchases, deposits, and credits are facilitated in the virtual wallet functionality. Various encryption and security functions may be included as requiring user password and/or biometric input.

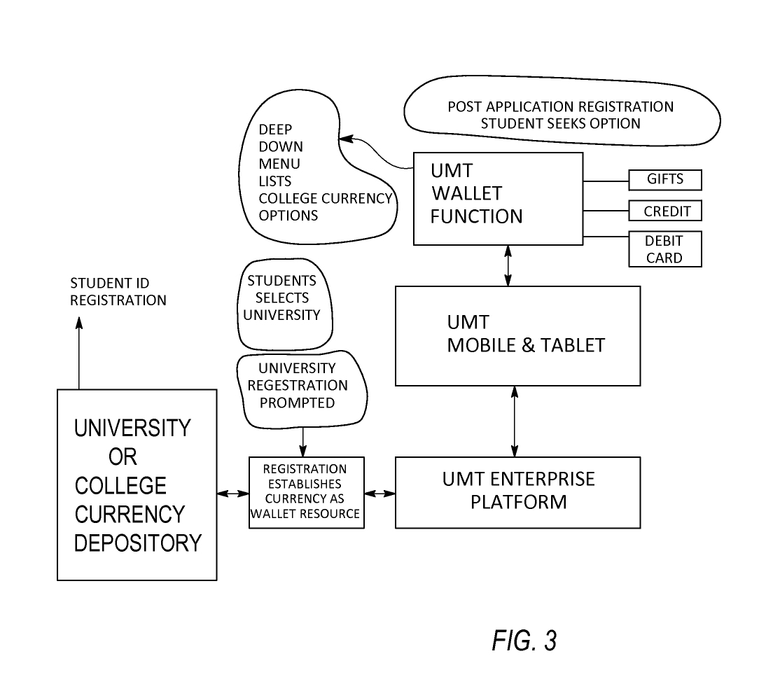

FIG. 3 shows an exemplary control scheme for integrating an artificial currency system with a virtual wallet. A University currency is used herein as exemplary, however, as one skilled in the art will readily recognize the teachings here may be applied to numerous third-party, artificial and/or point-based currency systems. Registered users of the system may integrate the artificial currency system as a payment/credit method for conducting financial transactions by linking the virtual wallet with their university account. In one embodiment, a user seeking to integrate the artificial currency system selects system-options to navigate to a list or currency and financial selections. At a virtual wallet preference or options interface a user may navigate to a drop-down menu or other selectable interface that enables the user to select a currency program associated with an organizational currency program such as an on-campus currency system. After the user selects the currency program, an organizational registration prompt is presented to the user enabling a user to provide information associated with the third-party organizational currency program such as login and password information, communication links such as a URL, or other credentialed-based information. Preferably, the credentials and registration information is authenticated by the third-party organization. An authenticated registration establishes the artificial currency as a selectable option in the virtual wallet—the option may be made to be the default option upon user selection.

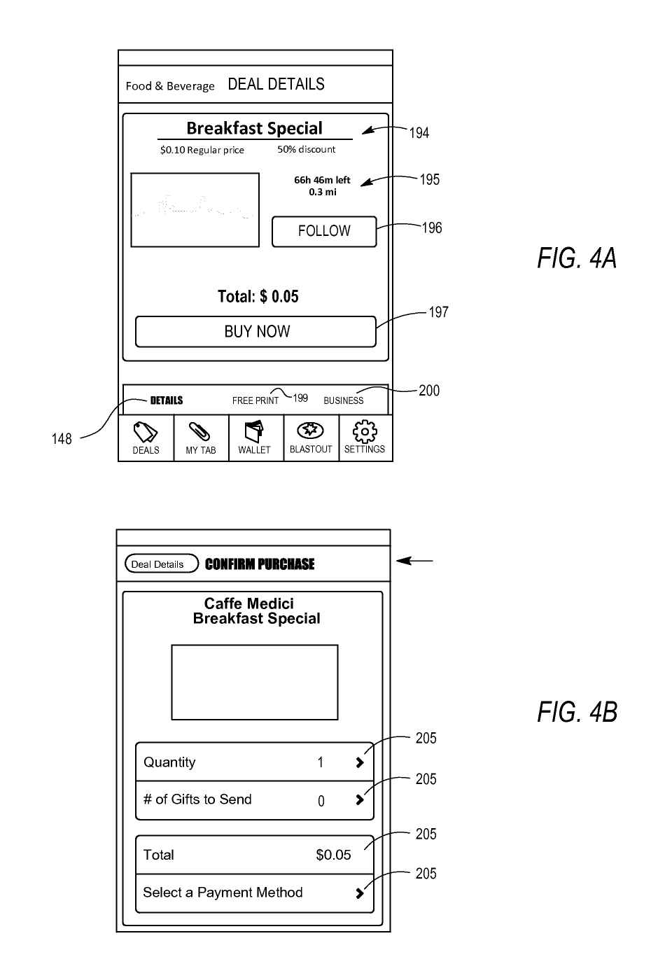

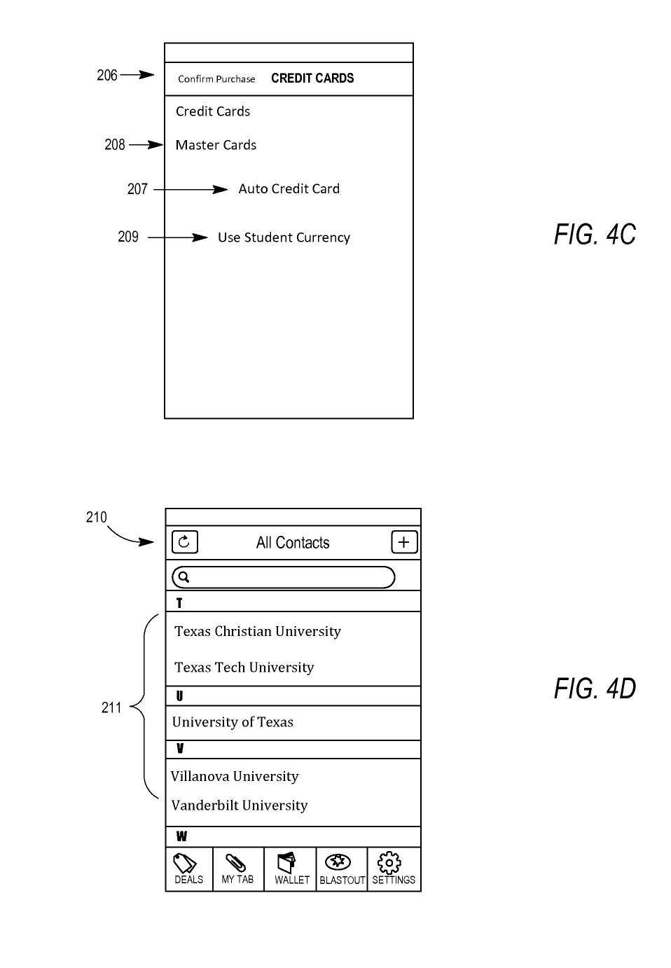

FIG. 4A shows exemplary user interfaces for a mobile device depicting a selected deal landing page display with an offer 194. The user interface may display a selected time and distance 195 associated with the offer, a follow this merchant activation to add to mytab archive of followed merchants 196, a buy now selection to acquire this offer 197, a details navigational button 198, an offer fine print navigational button 199, and a business navigational button 200. Upon selection of the buy-now navigational button 197, the user is directed to a confirm offer purchase landing page 201 as shown in FIG. 4B.

As FIG. 4B shows, the user may, in one embodiment, select a quantity 202, confirm to send as a gift 203 or adjust gift quantity, and view a total purchase amount to be taken from the virtual wallet system 204. To proceed with the order, a user will actuated a navigational button associated with selecting a payment method 205. Upon actuation of the select payment navigational button 205, the user is directed to a payment selection landing page 206 as shown in FIG. B3.

As FIG. 4C shows, the exemplary payment selection landing page may include functionality to add new payment methods 207, select a saved payment method such as a stored credit card 208, or functionality to add currency associated with the artificial payment system 209. In one embodiment, a saved payment method may be an artificial payment system such as a University currency program. Upon actuation of the artificial payment system 209, a user is directed to a drop down selection 210 of integrated third-party currency systems as shown in FIG. 4D.

As FIG. 4D shows, a user is presented with a scrollable list 211 of selectable third-party currency systems. To proceed with payment, a user selects a third-party currency system from the list. The user may then be directed to an authentication navigational interface to confirm and authenticate the payment or transfer of funds. In one embodiment, stored third-party artificial payment systems may include authentication information necessary to proceed with order confirmation without manual authentication such as login and password. Subsequent to authentication, the user may be offered a chance to confirm the purchase. Upon confirmation, a user is preferably directed to a purchased deal summary page. In one embodiment, to redeem the purchased offer, a user must navigate to a redeem offer display landing page wherein the user interface displays a scannable code or a proprietary alphanumeric code for entry into a vendors computing device.

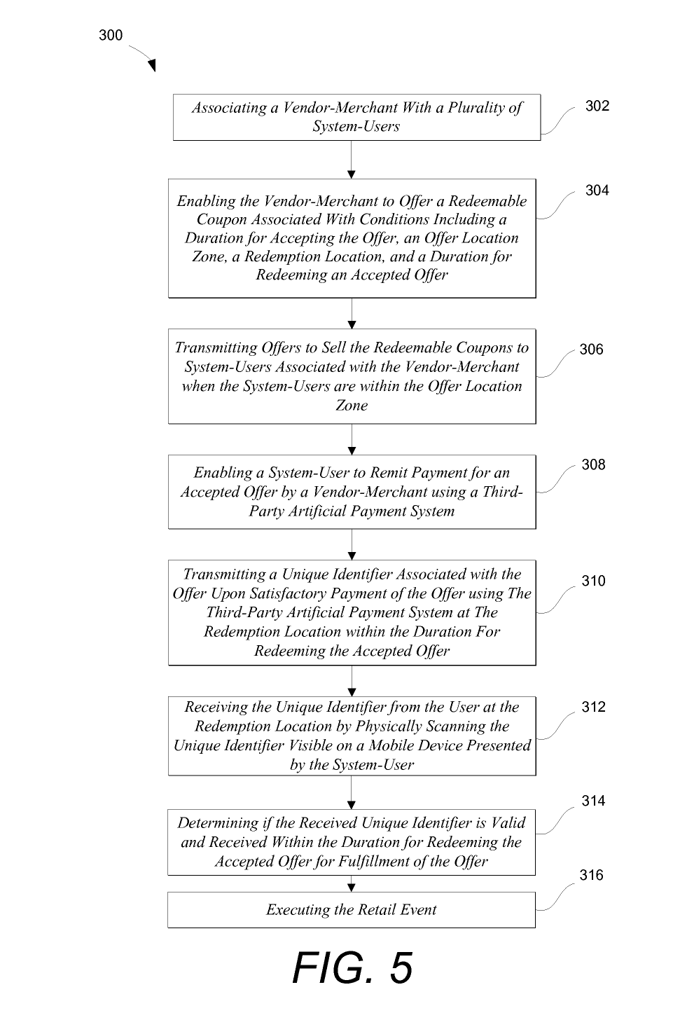

FIG. 5 shows an exemplary control scheme 300 for facilitating the merchant-customer retail events using the financial transaction facilitation system described herein above. FIG. 5 is shown and described with reference to a University artificial currency system however, as described herein, one of multiple third-party and artificial payment systems may be integrated into the system. Within the context of a university payment system, the University sponsor is an entity defined as the global sponsor of the financial transaction facilitation system. In operation, the system associates a vendor-merchant with a plurality of system-users via system user subscription or following requests 302. A vender-merchant, registered within the system, may then offer one or more redeemable coupons and one or more products or services associated with the redeemable coupons, wherein the redeemable coupons are associated with conditions including a duration for accepting the offer, an offer location zone, a redemption location, and a duration for redeeming an accepted offer 304. Upon generation of the offers, the system may than transmit or broadcast the offers and the redeemable coupons to system-users associated with the vendor-merchant when the system-users are within the offer location zone, wherein the offer location zone is defined as a predetermined distance from the vendor-merchant 306.

Once the system-user select an offer to purchase the system enables the system-user to remit payment for an accepted offer by a vendor-merchant using a third-party artificial payment system 308. Upon transfer of payment, the system transmits a unique identifier associated with the offer upon satisfactory payment of the offer using the third-party artificial payment system, wherein the unique identifier is only acceptable by a vendor-merchant at the redemption location within the duration for redeeming the accepted offer 310. The unique identifier from the system-user at the redemption location is redeemed by physically scanning the unique identifier visible on a mobile device presented by the system-user 312. The system determines if the received unique identifier is valid and received within the duration for redeeming the accepted offer for fulfillment of the offer 314. Upon determination of a valid offer with the specified duration the system executes the retail event associated with the offer 316.

A system user initiates a purchase of the offer using the process described herein above, using an artificial payment system to make payment. The system contacts the third-party University as global sponsor, in one embodiment, to confirm that the artificial currency will cover the price of the offering. In one embodiment, transaction fees may be applied or sent to the University and/or the system owner. Subsequent to confirmation that the balance will cover the purchase price, the system approves the purchase and releases the funds to the system vendor. Confirmation of the purchase is then sent to the system user.

In an exemplary embodiment, a system-user may select any deal in a mobile application or website. If they are interested in purchasing the offer, they must virtually actuate a “Buy Now” actuation button. After actuating the Buy Now control button, a user must “Select a Payment Method.” The user can either add a credit card, choose a saved credit card, or select the option to use a third party artificial currency such as a University's currency to purchase an offer. After selecting the option to use an artificial currency, a list of all participating third party currencies drop down allowing the user to select the appropriate option. The next step depends on which third party currency the user selected, but for the majority of these third party currencies, a user must enter their appropriate information (usually an id# and password) to access their funds that exist in this third party account. Funds may be pulled to Wallet (net of University share a hold is put on the University Currency account of the User, and collected by UMT from the University twice monthly) or released to a global sponsor during the normal cooperating merchant payment cycle, depending on the global sponsor policy terms and conditions. The global sponsor, having taken a hold against funds, now provides the user a credit in their wallet. The user, having established available credit to purchase, makes purchase. The purchase now resides in wallet to be redeemed by user and merchant. The system reconciles the debit against the user balance with an actual purchase made, and creates an invoice for the artificial currency account. Post redemption, the global sponsor sends the merchant their contracted share of the net purchase amount. When the artificial currency account is settled, it may forward the amount due to an entity associated with the artificial currency system, net of the global sponsor fee.

In another exemplary operation embodiment, the system generates a merchant campaign based upon input from a merchant-user. Each merchant campaign may include one or more goods or services each associated with one or more terms of an offer for the goods or services such as an offer price, a duration for accepting the offer, an offer location zone, a redemption location, and a duration for redeeming an accepted offer. The system may receive instructions from a customer-user to subscribe to a merchant campaign.

The system receives location-based information indicative of the customer-user's physical location, although the system may monitor the customer-user's physical location at any time through the process. Subsequent to following a merchant campaign, the system transmits the offer to the customer-user when the received location-based information indicative of the customer-user's physical location is within the offer location zone while the customer-user is subscribed to the merchant campaign. Once one or more offers are received by the customer-user, the customer-user may select any received offer and transmitted acceptance of the selected offer. The system receives the acceptance and checks for satisfaction of a predetermined contingency, e.g., payment using the artificial currency. Upon valid acceptance and satisfaction of the contingency, the system transmits a unique identifier, e.g., the QR code, for redemption when the customer-user's physical location is within the offer location zone. After physically traveling to the redemption location, or remaining within, the consumer-user presents the unique identifier for validation. The system then validates the unique identifier and fulfills the offer.

By tying operation of the system to geography and location of the consumer-user and offer redemption location, fraud is reduced and consumer-user receive more useful and relevant offers, thereby decreasing risk that potential customers will ignore the discounting offer or future discounting offers. Fraud is further reduced by using an artificial currency with inherent possession tracking functionality.

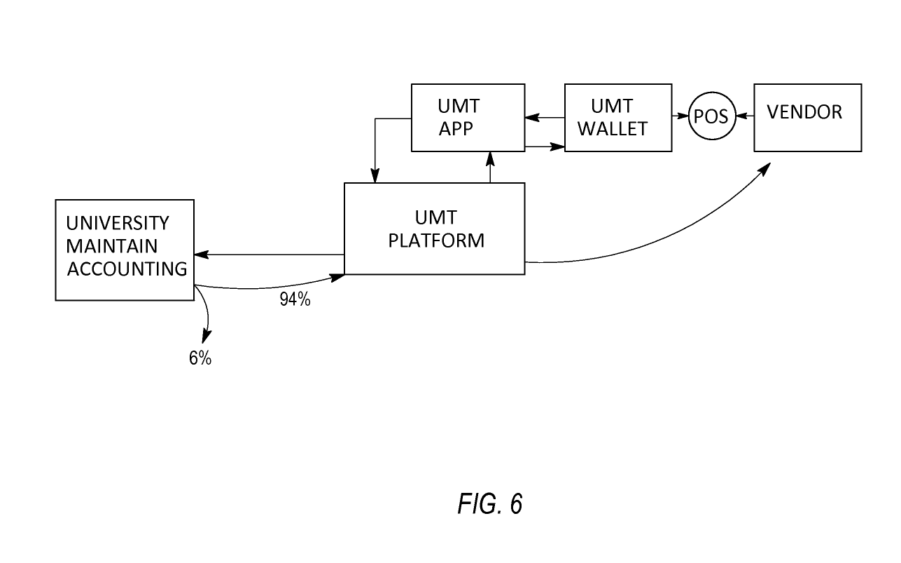

FIG. 6 shows an exemplary implementation of the financial transaction facilitation system. As FIG. 6 shows, in one embodiment, a global sponsor (‘University Maintain Accounting’) may track and report transaction within the system. Transactions are facilitated by a system-user having a mobile app (‘UMT APP’) in communication with an artificial currency system (‘UMT WALLET’) and enterprise platform (‘UMT PLATFORM’). The system-user desirous of a product or service from a vendor initiates the purchase through the mobile app, which in turn prompts the artificial currency system to interact at the point-of-sale (‘POS’) at a location of a merchant-vendor (‘VENDOR’), in one embodiment.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for facilitating merchant-customer retail events, the method comprising:
associating a vendor-merchant with a plurality of system-users;
enabling the vendor-merchant to offer one or more redeemable coupons and one or more products or services associated with the redeemable coupons, wherein the redeemable coupons are associated with conditions including a duration for accepting the offer, an offer location zone, a redemption location, and a duration for redeeming an accepted offer;
transmitting offers to sell the redeemable coupons to system-users associated with the vendor-merchant when the system-users are within the offer location zone, wherein the offer location zone is defined as a predetermined distance from the vendor-merchant;
enabling a system-user to remit payment for an accepted offer by a vendor-merchant using a third-party artificial payment system;
transmitting a unique identifier associated with the offer upon satisfactory payment of the offer using the third-party artificial payment system, wherein the unique identifier is only acceptable by a vendor-merchant at the redemption location within the duration for redeeming the accepted offer;
receiving the unique identifier from the user at the redemption location by physically scanning the unique identifier visible on a mobile device presented by the system-user;
determining if the received unique identifier is valid and received within the duration for redeeming the accepted offer for fulfillment of the offer; and
facilitating the retail event upon validation and redemption with the duration for redeeming the accepted offer.

2. The method of claim 1, wherein the location associated with the vendor-merchant is defined by GPS data.

3. The method of claim 1, wherein the unique identifier is a scannable QR code.

4. The method of claim 1, further comprising:
establishing an artificial currency account associated with each system-user and with each vendor-merchant.

5. The method of claim 1, further comprising:
generating an exchange rate between the artificial currency and a conventional currency; and
enabling vendor-merchants and system-users to electronically transfer conventional currency into and out of their artificial currency account.

6. The method of claim 1, further comprising:
enabling a third-party user to gift conventional currency into an artificial currency account of a selected system-user.

7. The method of claim 4, wherein an amount of the artificial currency on deposit that is associated with a particular system-user is determined based upon deposits of conventional currency, purchase history, and successful performance of incentive-based activities.

8. The method of claim 1, further comprising:
establishing an entity as a global sponsor of a financial transaction facilitation system configured to facilitate the merchant-customer retail events;
generating metrics associated with completed merchant-customer retail events, wherein at least one metric includes an amount of artificial currency paid;
determining a portion of the amount of artificial currency paid that is transferable to the entity based upon a predetermined percentage; and
transferring the determined portion to an account associated with the entity.

9. A non-transitory computer readable memory that stores a program code executed by a computer for facilitating merchant-customer retail events, comprising:
associating a vendor-merchant with a plurality of system-users;
enabling the vendor-merchant to offer one or more redeemable coupons and one or more products or services associated with the redeemable coupons, wherein the redeemable coupons are associated with conditions including a duration for accepting the offer, an offer location zone, a redemption location, and a duration for redeeming an accepted offer;
transmitting offers to sell the redeemable coupons to system-users associated with the vendor-merchant when the system-users are within the offer location zone, wherein the offer location zone is defined as a predetermined distance from the vendor-merchant;
enabling a system-user to remit payment for an accepted offer by a vendor-merchant using a third-party artificial payment system;
transmitting a unique identifier associated with the offer upon satisfactory payment of the offer using the third-party artificial payment system, wherein the unique identifier is only acceptable by a vendor-merchant at the redemption location within the duration for redeeming the accepted offer;
receiving the unique identifier from the user at the redemption location by physically scanning the unique identifier visible on a mobile device presented by the system-user; and
determining if the received unique identifier is valid and received within the duration for redeeming the accepted offer for fulfillment of the offer.

10. The method of claim 9, wherein the location associated with the vendor-merchant is defined by GPS data and wherein the unique identifier is a scannable QR code.

11. The method of claim 9, further comprising:
establishing an artificial currency account associated with each system-user and with each vendor-merchant.

12. The method of claim 9, further comprising:
generating an exchange rate between the artificial currency and a conventional currency; and
enabling vendor-merchants and system-users to electronically transfer conventional currency into and out of their artificial currency account.

13. The method of claim 9, further comprising:
enabling a third-party user to gift conventional currency into an artificial currency account of a selected system-user.

14. The method of claim 13, wherein an amount of the artificial currency on deposit that is associated with a particular system-user is determined based upon deposits of conventional currency, purchase history, and successful performance of incentive-based activities.

15. The method of claim 9, further comprising:
establishing an entity as a global sponsor of a financial transaction facilitation system configured to facilitate the merchant-customer retail events;
generating metrics associated with completed merchant-customer retail events, wherein at least one metric includes an amount of artificial currency paid;
determining a portion of the amount of artificial currency paid that is transferable to the entity based upon a predetermined percentage; and
transferring the determined portion to an account associated with the entity.

16. A computer system comprising a processor, a memory and an input output device wherein the memory stores computer executable instructions and the processor is adapted to execute computer executable instructions for dividing an amount, the computer executable instructions comprising:
associating a vendor-merchant with a plurality of system-users;
enabling the vendor-merchant to offer one or more redeemable coupons and one or more products or services associated with the redeemable coupons, wherein the redeemable coupons are associated with conditions including a duration for accepting the offer, an offer location zone, a redemption location, and a duration for redeeming an accepted offer;
transmitting offers to sell the redeemable coupons to system-users associated with the vendor-merchant when the system-users are within the offer location zone, wherein the offer location zone is defined as a predetermined distance from the vendor-merchant;
enabling a system-user to remit payment for an accepted offer by a vendor-merchant using a third-party artificial payment system;
transmitting a unique identifier associated with the offer upon satisfactory payment of the offer using the third-party artificial payment system, wherein the unique identifier is only acceptable by a vendor-merchant at the redemption location within the duration for redeeming the accepted offer;
receiving the unique identifier from the user at the redemption location by physically scanning the unique identifier visible on a mobile device presented by the system-user; and
determining if the received unique identifier is valid and received within the duration for redeeming the accepted offer for fulfillment of the offer.

17. The method of claim 16, further comprising:
establishing an entity as a global sponsor of a financial transaction facilitation system configured to facilitate the merchant-customer retail events;
generating metrics associated with completed merchant-customer retail events, wherein at least one metric includes an amount of artificial currency paid;
determining a portion of the amount of artificial currency paid that is transferable to the entity based upon a predetermined percentage; and
transferring the determined portion to an account associated with the entity.

18. The method of claim 16, wherein the location associated with the vendor-merchant is defined by GPS data and wherein the unique identifier is a scannable QR code.

19. The method of claim 16, further comprising:
establishing an artificial currency account associated with each system-user and with each vendor-merchant;
generating an exchange rate between the artificial currency and a conventional currency; and
enabling vendor-merchants and system-users to electronically transfer conventional currency into and out of their artificial currency account.

20. The method of claim 16, further comprising:
enabling a third-party user to gift conventional currency into an artificial currency account of a selected system-user, wherein an amount of the artificial currency on deposit that is associated with a particular system-user is determined based upon deposits of conventional currency, purchase history, and successful performance of incentive-based activities.
